(19) United States
(12) Patent Application Publication
(10) Pub. No.: US 2012/0117772 A1
(43) Pub. Date: May 17, 2012

(54) Device for working, in particular stamping and joining, of a work piece, and a working tool

(75) Inventors: Dieter Nagel, Karlsbad (DE); Ingo Nagel, Karlsbad (DE)

(73) Assignee: SONOTRONIC Nagel GmbH, Karlsbad (DE)

(21) Appl. No.: 13/288,572

(22) Filed: Nov. 3, 2011

(30) Foreign Application Priority Data
Nov. 3, 2010 (DE) 20 2010 014 913.4
Nov. 3, 2010 (EP) 10 014 231.4

(51) Int. Cl. B23Q 3/18; B23P 17/00

(52) U.S. Cl. 29/56

(57) ABSTRACT

An apparatus for working has an upper tool. A lower tool co-operates with the upper tool. The lower tool is arranged on a turntable of the apparatus. The turntable is pivotable from a loading position, in which the turntable is remote from the upper tool, to a working position, in which the lower tool is aligned with the co-operating upper tool. By a pivoting movement of the turntable, the work piece, inserted into the apparatus when the turntable is in the loading position, as well as the lower tool, can be brought under the upper tool.

The invention relates to an apparatus for working, particularly for punching and connecting of a work piece, particularly of plastic parts for a vehicle, wherein the apparatus comprises at least one working tool having an upper tool and a lower tool co-operating with the upper tool, wherein the upper tool or a plurality of upper tools are arranged in the apparatus.

The invention further relates to a working tool for an apparatus for working, particularly for punching and connecting of a work piece, particularly of plastic parts for vehicles, wherein the apparatus has an upper tool and the working tool has a lower tool with at least two working units movable to and away from the upper tool, wherein the lower tool comprises at least one moving device by which at least the first working unit and the second working unit are optionally movable relatively to the upper tool of the working tool, wherein at least one moving device comprises a carriage having a carriage table upon which at least one working unit is arranged and wherein the carriage table of the carriage is movably arranged on a carriage guide.

Such an apparatus is known from EP 1 586 427. The punching tool is arranged in a punching station and the connecting tool formed as welding or glueing tool is provided in a welding or glueing station. The known apparatus comprises a shifting table having a receptable for the work piece to be worked on, which is movable back and forth between the punching station and the welding or glueing station. The operation of the known apparatus is as follows: Firstly, the shifting table is arranged in the area of the welding or glueing station to insert the work piece in its receptable. After fixing of the work piece in the receptable, the receptable is lifted by an holder until the welding tools provided in the receptable are free. The work piece is moved to the punching station by the shifting table. A die is arranged in the punching station in a correspondingly low position, so that it can be moved over collision free by the side walls of the work piece when the receptable is lifted until it is arranged in the center of a U-shaped space of the work piece. Thereafter, the work piece is lowered by lowering the holder until it is laid up with its underside on the die. In the further process a punching is performed with one or a plurality of punching dies by operation of a corresponding punching cylinder to provide the work piece with at least one hole. After finishing of the punching process the receptable is lifted until the die is free. Then, the shifting table is moved together with the work piece into the welding station and finally the receptable is lowered until its lower side closely faces the welding tools. Thereafter a welding process is performed by pressing a sonotrode by means of its working stroke from the underside against the work piece. After completion of the welding process the finished work piece is removed as long as the receptable is still lowered and a new work piece is put on the receptable and the described working steps are repeated for the new work piece.

Such an apparatus has the drawback that it builds very deep. The punching station and the welding station are arranged spatially separated and are connected by the shifting table which shuttles between theses two stations. The known apparatus therefore needs a huge space. Moreover, the known apparatus—also due to its size—builds very expensive because—to meet the required assembly tolerances—the shifting table together with the holder and the receptable need to have high precision, so that no deviations of the position of the work piece in the said stations arise.

From DE 24 41 965 A1 a system for handling in particularly a press open at one side is known, comprising a tool holder operating according to the revolver principle and a robot. These two devices together automatically operate the press open at one side by successively supplying the necessary tools and the work pieces into the opening or the gap of the press, respectively. The revolver has four crosswise arranged arms. Each arm has a tool set at its free end which generally consists of an upper and lower tool. When each of the tool sets are moved through the press they perform a working process on the work piece. The task which the robot has to fulfill is to change the work pieces in the arms of the revolver of the tool holder when the revolver arm is passing by the robot. The revolver performs a step-by-step revolution around a vertical axis and has two arms which are movable back and forth around an additional vertical axis. The robot supplies the revolver with blanks by receiving the blanks from a blank storage and moving each received blank to the revolver, where the blank is received by the tool set which should perform the first step of the process.

From DE 196 27 671 a glass press device is known having a swiveling form for reaching a feed, press and removal station. The swiveling form is build on a tilting or swiveling table movable around a swiveling axis perpendicular to a press die axis and simultaneously perpendicular, parallel or having an angle to a horizontal feed axis corresponding to the production direction, so that the swiveling form can be swiveled to the feed position by a swivel angle not corresponding to the vertical die axis in direction to the drop point of the feeder, and from there in a perpendicular position to the press postion in correspondence with die axis and from there to the removal postion by a second swivel angle opposite to the direction of the feeder and from there directly back to the feed position.

Document EP 1 607 173 describes a work piece receptable for a tool machine comprising a rectangular table pivotable around a horizontal axis. This table is pivotable from a substantially horizontal position, in which the work piece is arranged and clamped on the surface of the table, to a vertical position, in which the surface of the table is aligned to a working station.

A working tool of the afore-mentioned kind is known from EP 1 798 019. The document describes an apparatus for successively performing the steps of punching, milling, welding and/or glueing operations on large surfaced three-dimensional plastic parts for vehicles, particularly of bumpers, having at least one receptable for the plastic parts as well an upper tool and a lower tool. The lower tool and the upper tool comprise tools which are movably mounted at least partially parallel or in direction of a predetermined axis, respectively, and serve to provide the plastic parts first with a punching hole and then to perform at least one further working step by milling, welding and/or glueing in the area of the punching hole. The receptable is stationary arranged and the tools of the lower or upper tool are mounted on a holder mounted transversely moveable to the axis. The tools mounted thereon can successively be brought in working position, which is determined by a predetermined working position of the plastic parts. For this it is provided that the upper tool and the lower tool are fixed on a bracket having a rectangular or square cross section, wherein the lower tool is mounted on a holder moveable relatively to the bracket and to the receptable. A first tool being a die, needed for a punching process, is mounted on this holder. Furthermore, a guiding track is provided, being connected with the bracket, along which the holder can be moved. The guide is inclined, so that the holder can be lowered relatively to the work piece to be worked on, so that the tool can be moved out of the work piece in downward direction. A cylinder piston arrangement serves for moving the holder, having a piston rod fixed on the holder and its cylinder is fixed on the bracket. In moving direction of the holder, behind the first tool, a second tool is provided which is also fixed on the holder and is preferably a sonotrode in case of plastic welding by ultrasonics. This second tool is additionally movably mounted transverse to the moving track of the holder. A further cylinder piston arrangement serves for moving the second tool, wherein its cylinder is fixed on the holder and its piston rod is fixed on the second tool.

The known working tool has the drawback that is has to be built relatively complex to fulfill the requirements in respect to the precise positioning of the two tools of the lower tool when a work piece is worked on.

It is an object of the present invention to further develop an apparatus as mentioned above, so that the apparatus according to the invention is build more compact, and to provide a working tool which is particularly suitable for the apparatus according to the invention.

To solve this problem, the apparatus according to the invention proposes, that this lower tool or this plurality of lower tools is arranged on a turntable of the apparatus, which is pivotable from a loading position, in which the turntable is remote from the upper tool or the plurality of upper tools, to a working position in which the lower tool or the plurality of lower tools is aligned with the co-operating upper tool or the plurality of co-operating upper tools, so that the work piece, which is inserted into the apparatus during the loading position of the turntable, as well as the lower tool or the plurality of lower tools can be brought under the upper tool or the plurality of upper tools by a pivoting movement of the turntable.

By the measures according to the invention an apparatus is provided, which excels by its particularly compact construction and thus needs less space in assembly halls. As it is now provided by the invention, that the work piece inserted in the turntable is brought under the upper tools of the working tool or the plurality of working tools by a pivoting movement, it is possible, in advantageous manner, to avoid the use of the shifting table used up to now by the known apparatuses. In the working position of the turntable, the working of the work piece is then performed particularly a punching as well as connecting, hereby particularly a welding. This is made possible by arranging the lower tools in the turntable which therefore follow its movement.

An advantageous embodiment of the invention provides, that the apparatus comprises a handling device by which the work piece arranged on the turntable can be engaged in the working position of the apparatus and is movable away from the lower tool or the plurality of lower tools. Such a measure has the advantage, that hereby a removal of the finished work piece from the apparatus is possible in a simple manner, while simultaneously to the removal process the turntable can be moved back to the receiving position and can be newly loaded.

The working tool according to the invention provides, that the shift motion of the carriage is substantially orthogonal to the direction of the feed motion of the lower tool to its associated upper tool or is in this direction.

The working tool according to the invention excels in that by a simple manner different working units are positionable under the upper tool of the working tool. Advantageously is provided, that at least one of the working units comprises a die, which co-operates with the punching die of the upper tool, and that at least one working unit of the lower tool is provided as a connecting unit. The working tool according to the invention thus advantageously forms a combined punching and connecting tool and allows that in the working position of the apparatus successively a punching and a connecting process can be performed without changing the position of the work piece.

Advantageous embodiments of the invention are subject of dependable claims.

Further advantages and details of the invention disclosed in the preferred embodiments, which are described by means of the figures. There is shown:

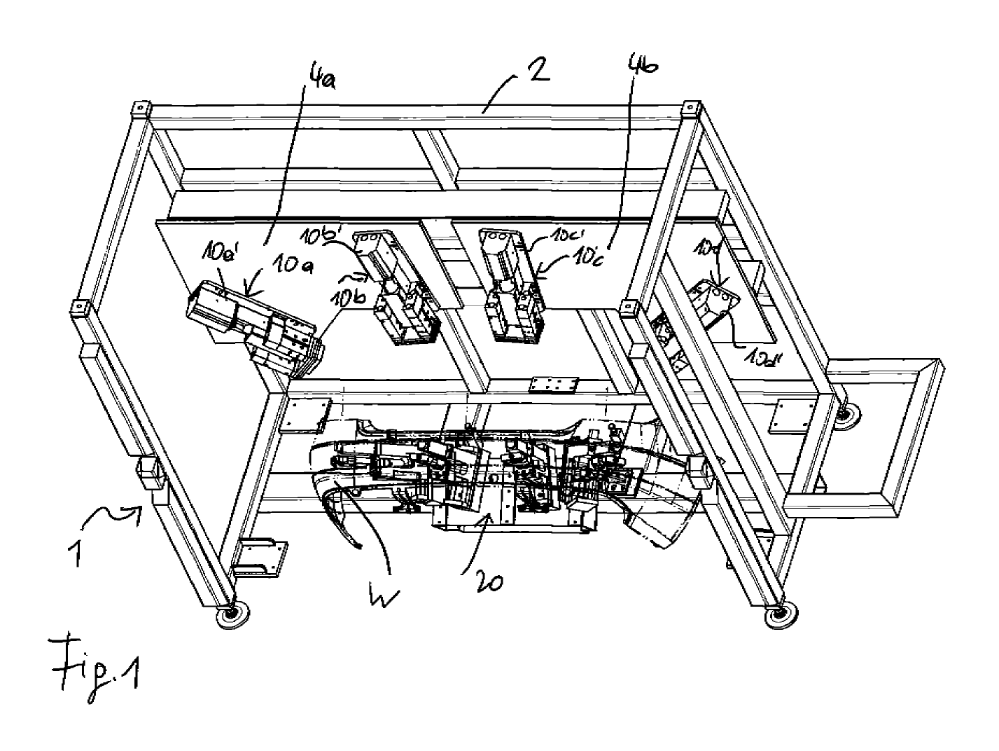

FIG. 1: a schematic view of a first embodiment of an apparatus in a loading position;

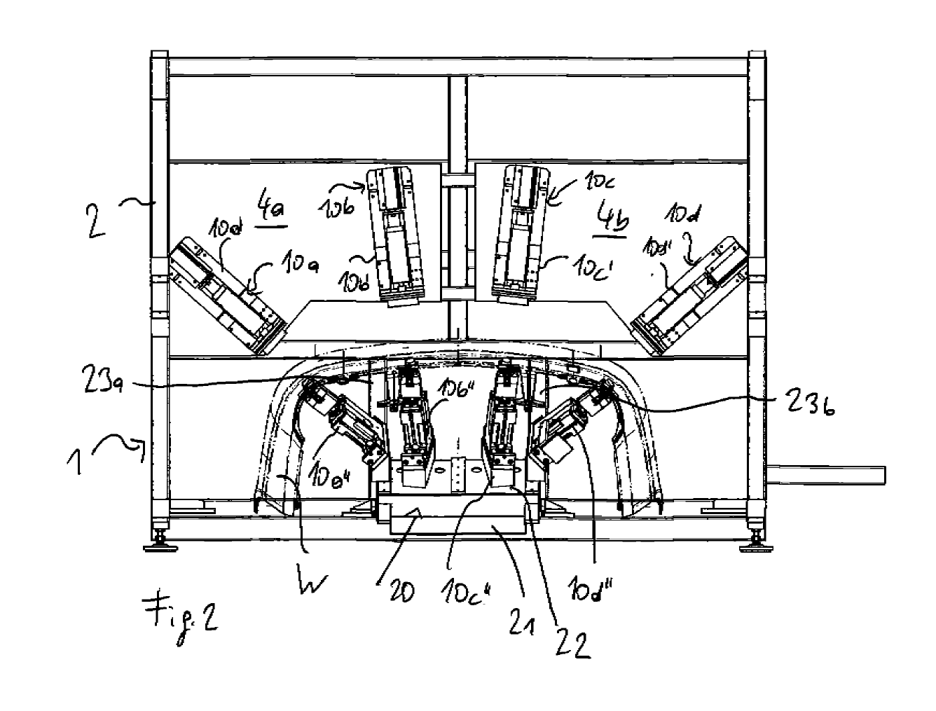

FIG. 2: a front view of the first embodiment of the apparatus;

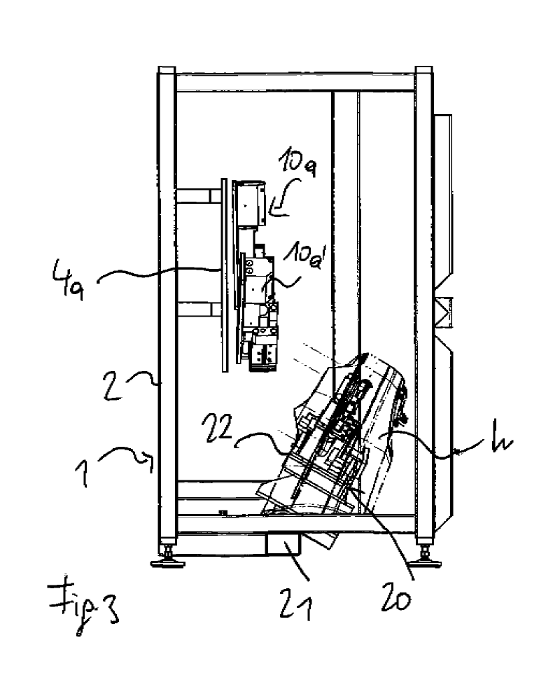

FIG. 3: a side view of the first embodiment of the apparatus;

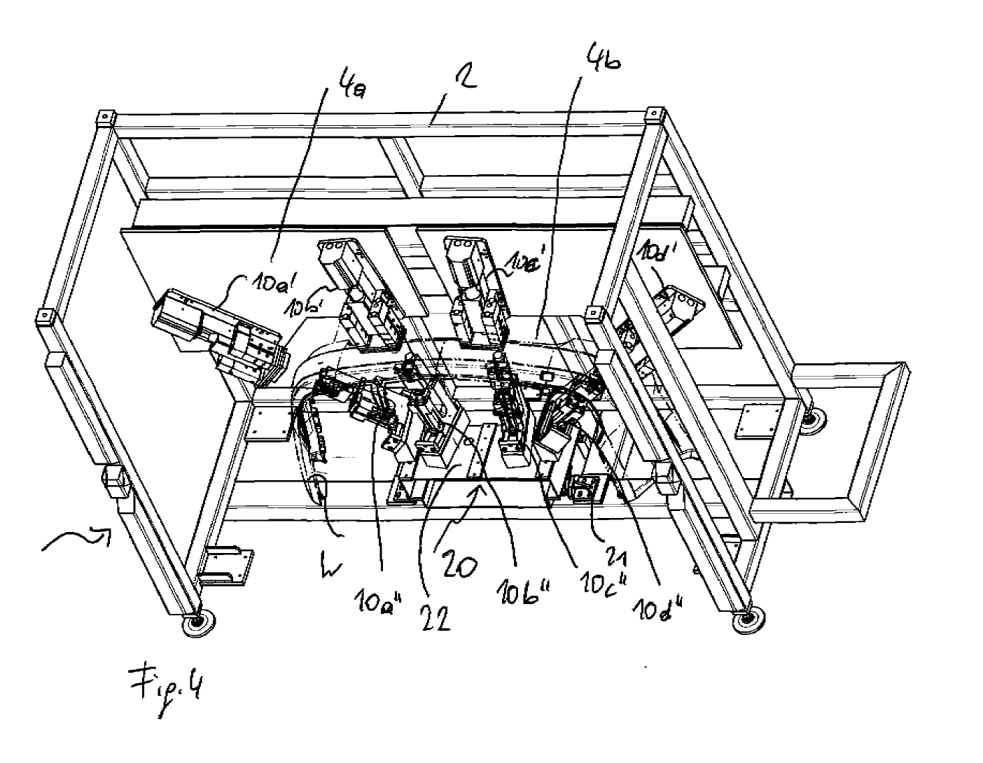

FIG. 4: a perspective view of the first embodiment of the apparatus in a working position;

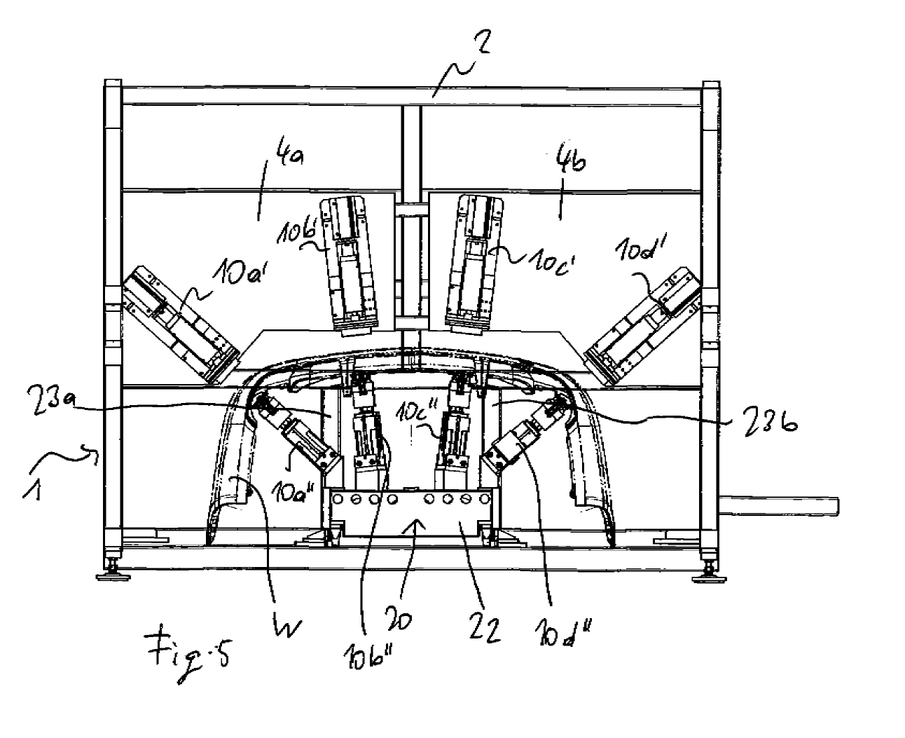

FIG. 5: a front view of the first embodiment of the apparatus in its working position;

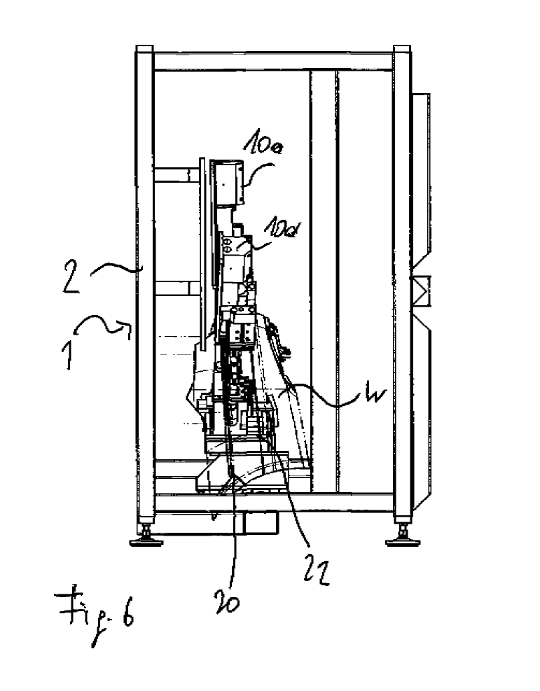

FIG. 6: a side view of the first embodiment of the apparatus in its working position;

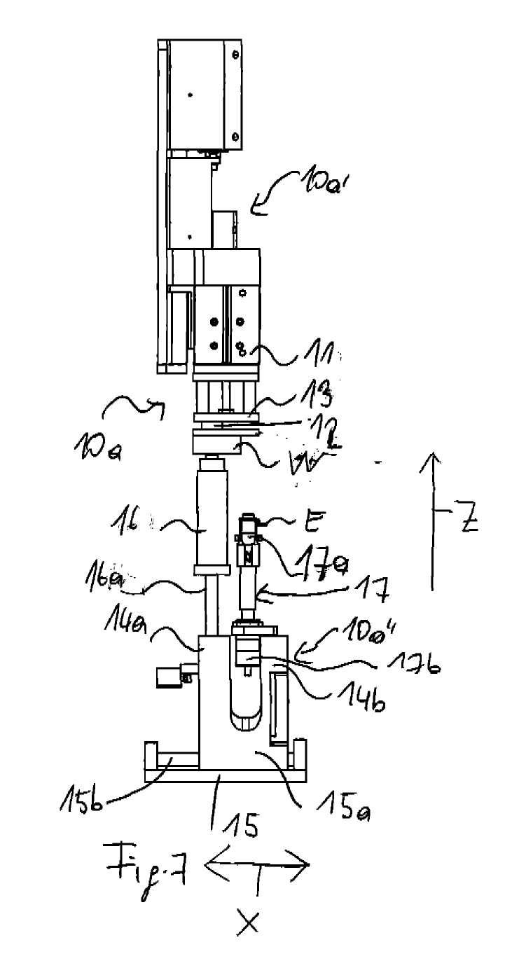

FIG. 7: a front view of a first embodiment of a working tool in a first working position;

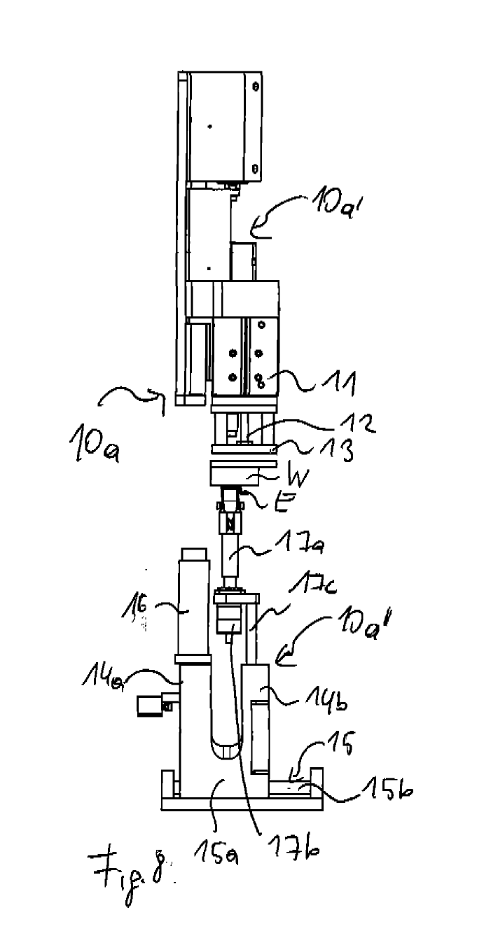

FIG. 8: a front view of the first working tool of FIG. 7 in a second working position;

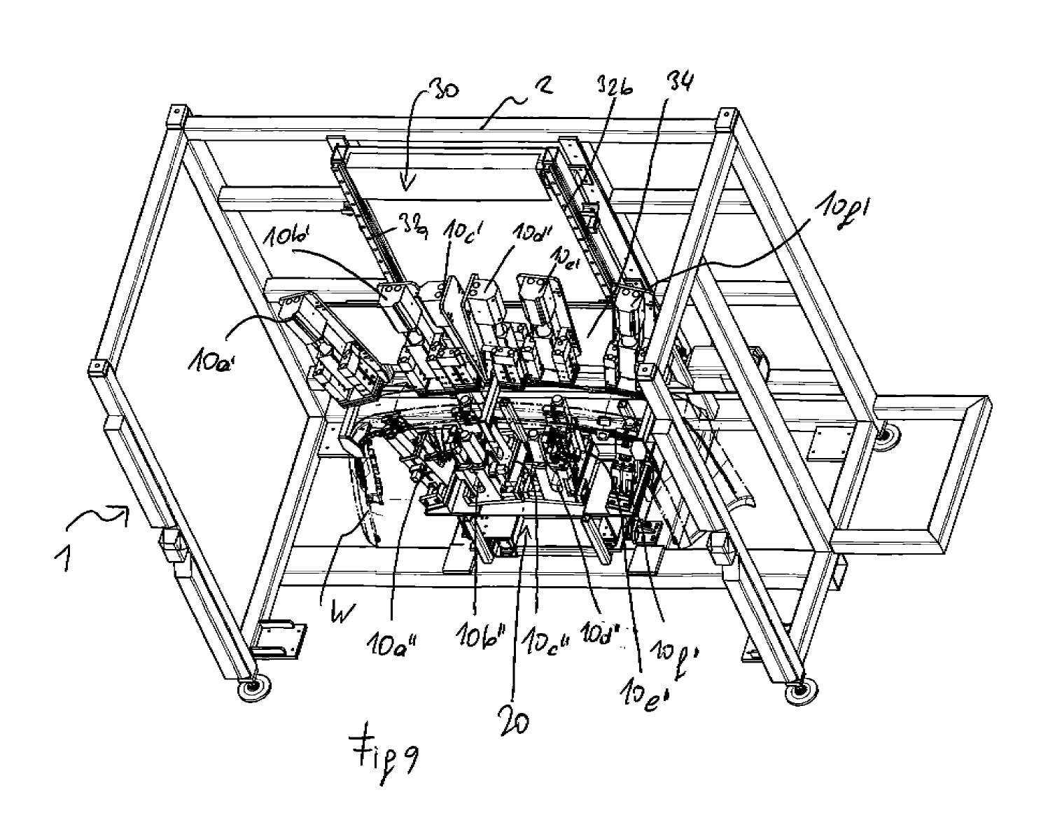

FIG. 9: a perspective view of a second embodiment of the apparatus in its working position;

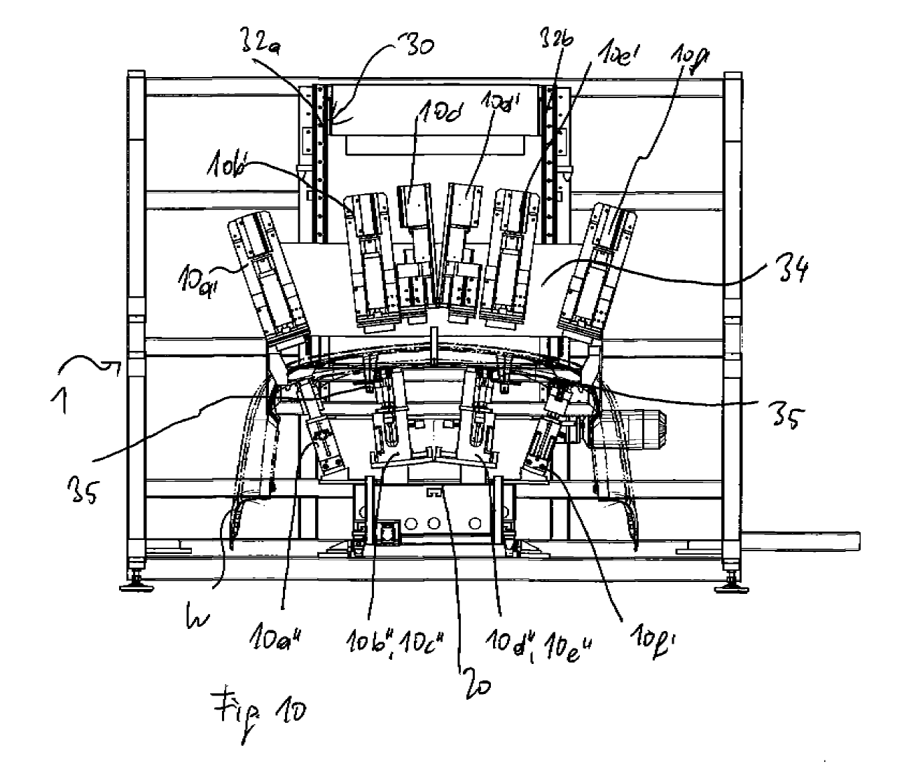

FIG. 10: a front view of the second embodiment of the apparatus;

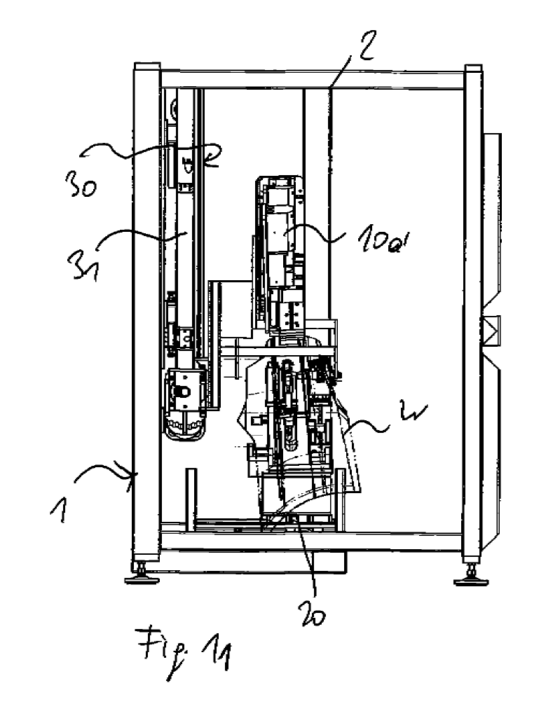

FIG. 11: a side view of the second embodiment of the apparatus;

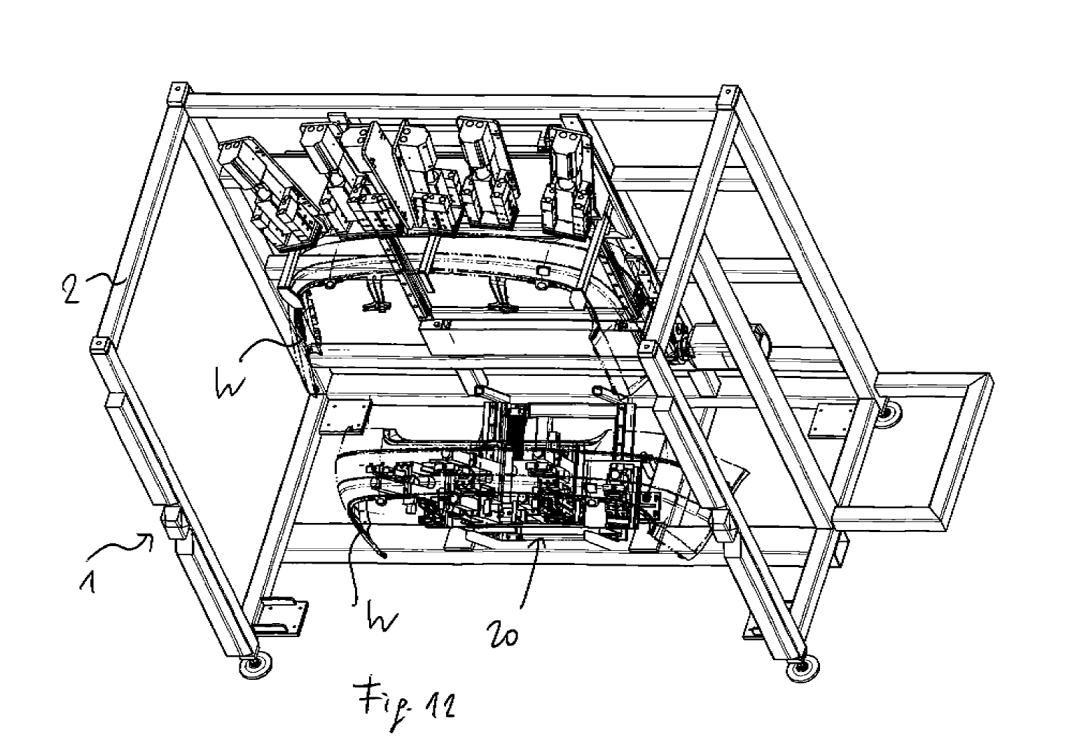

FIG. 12: a perspective view of the second embodiment of the apparatus in its loading position;

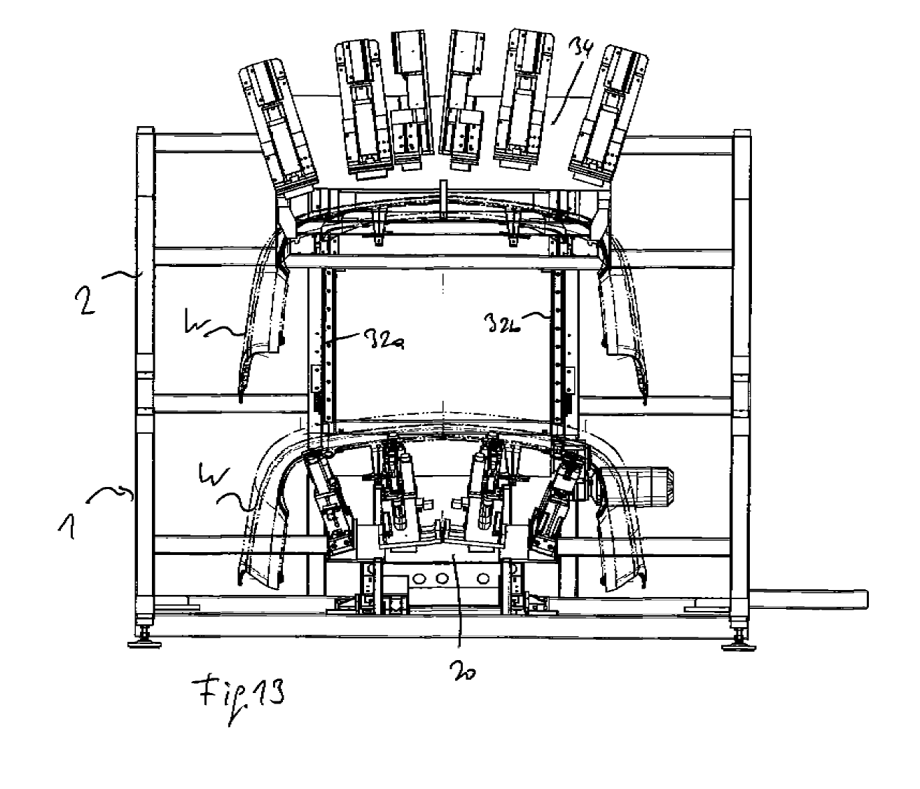

FIG. 13: a front view of the second embodiment of the apparatus;

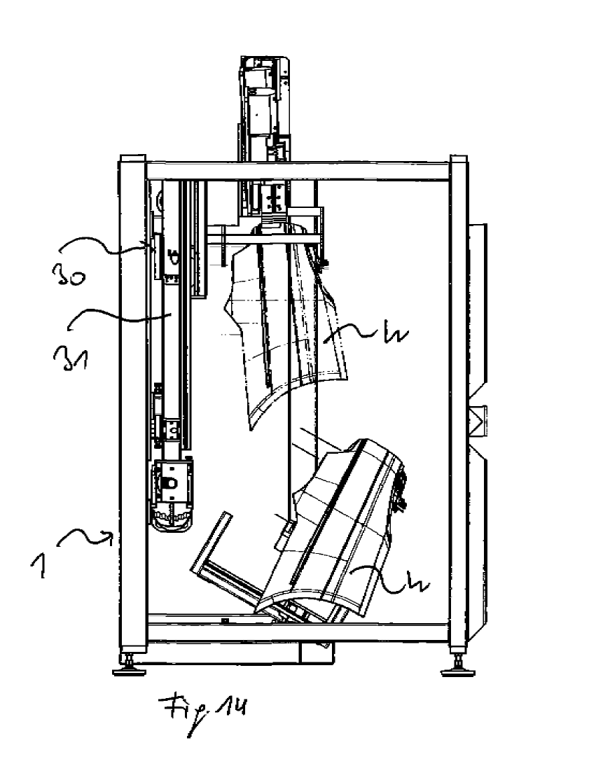

FIG. 14: a side view of the second embodiment of the apparatus;

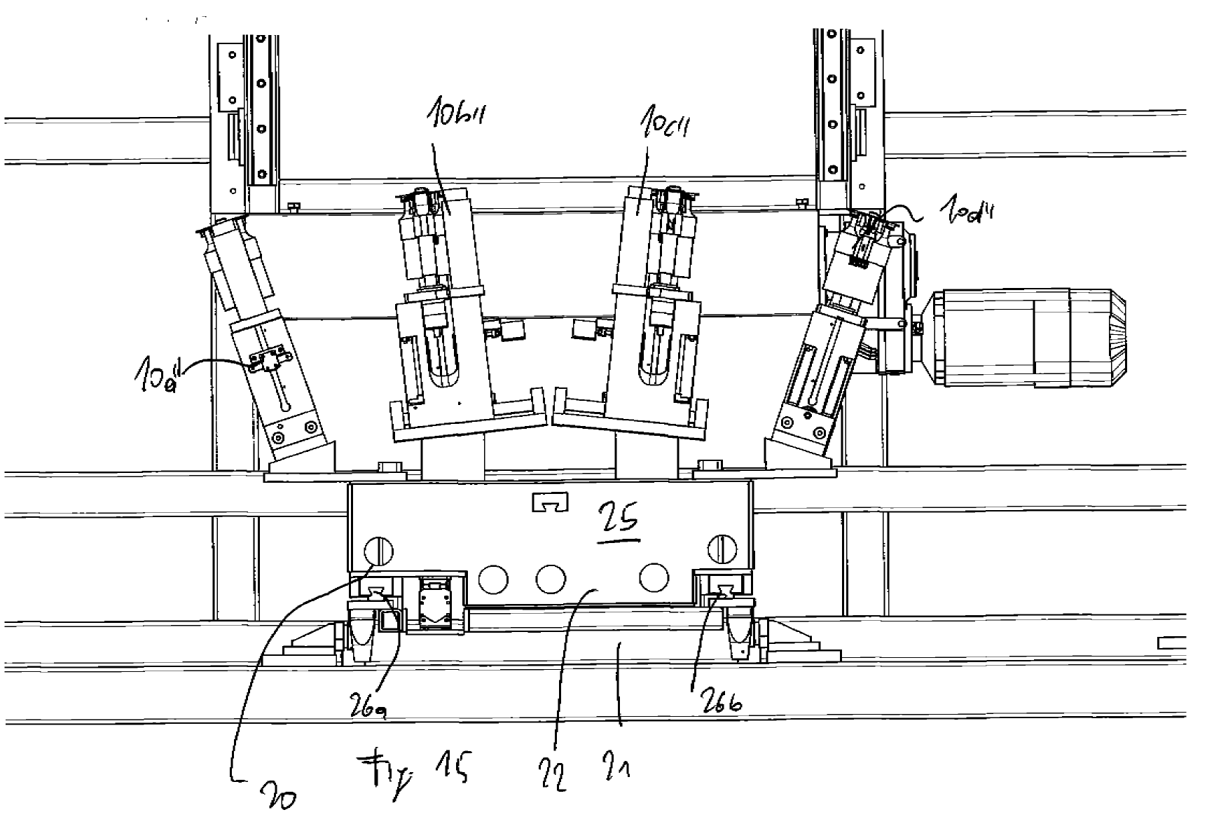

FIG. 15: an enlarged view of the under table;

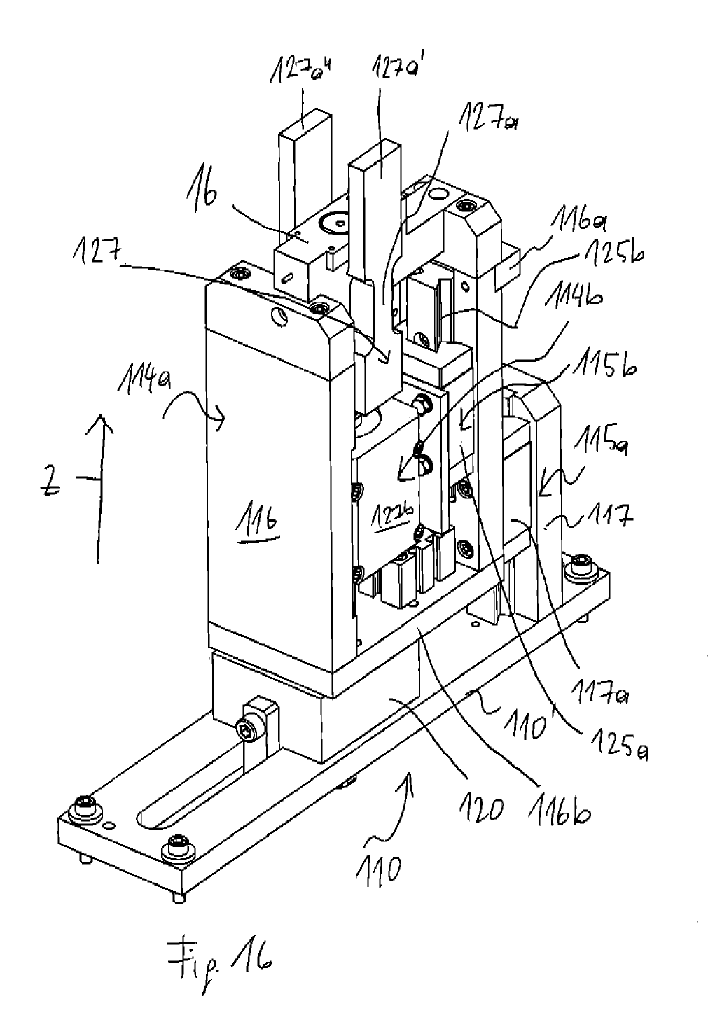

FIG. 16: a perspective view of a second embodiment of a working tool;

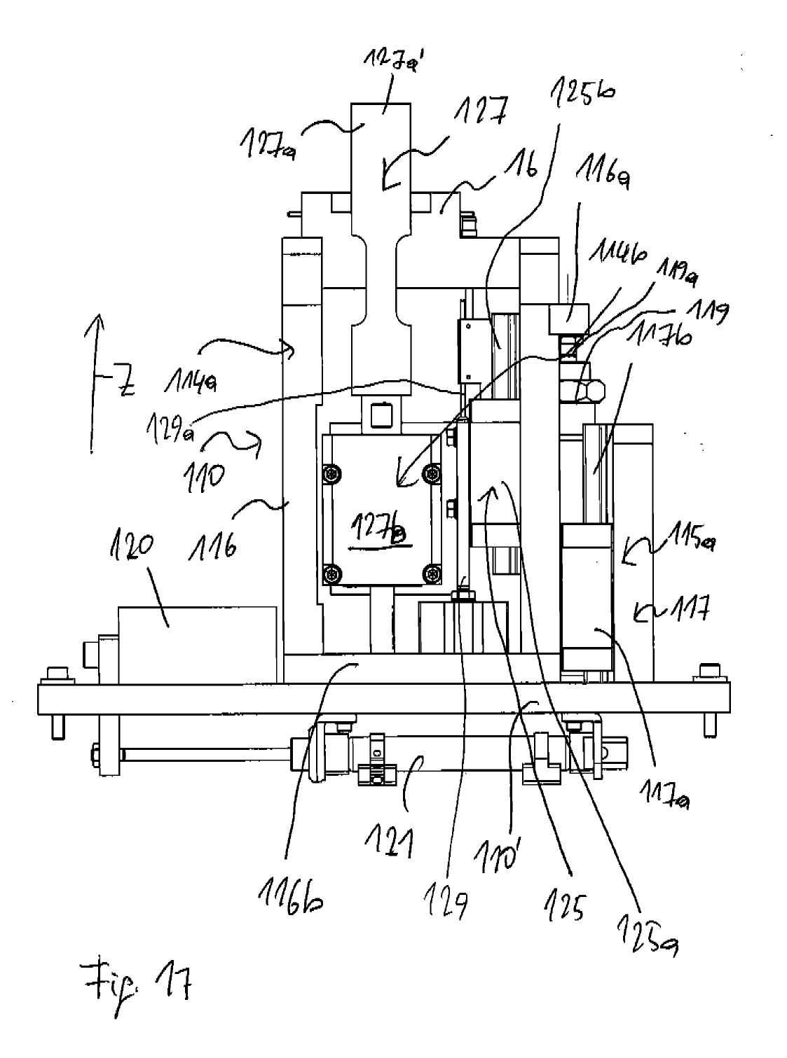

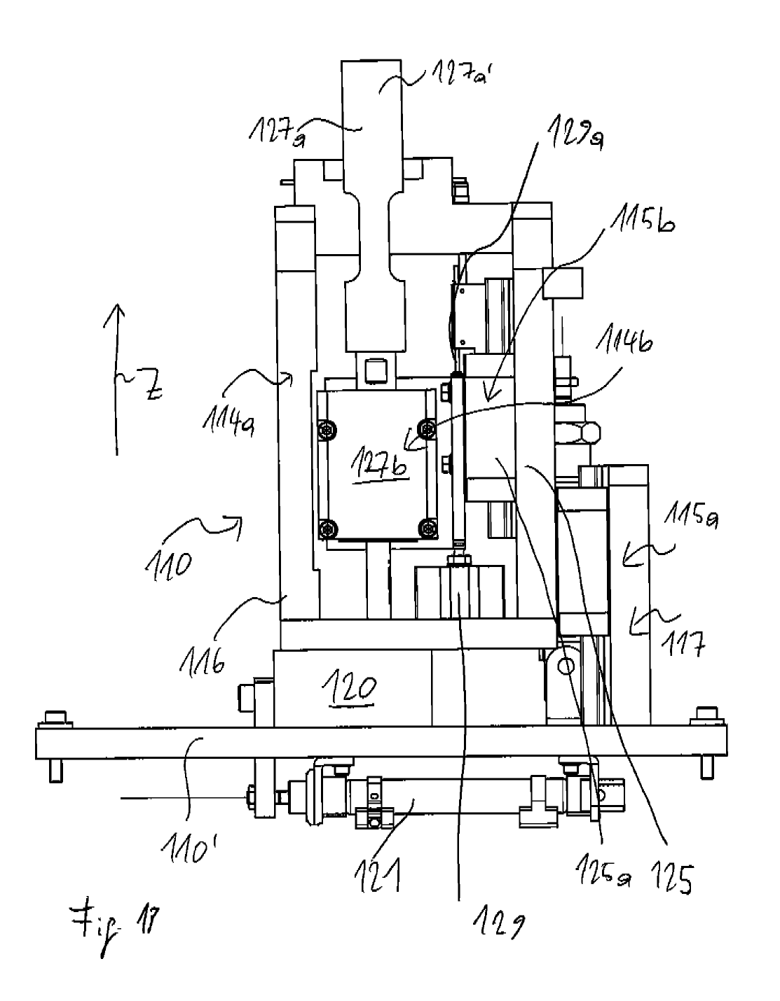

FIGS. 17 and 18: a front view of the second embodiment of the working tool in two different positions;

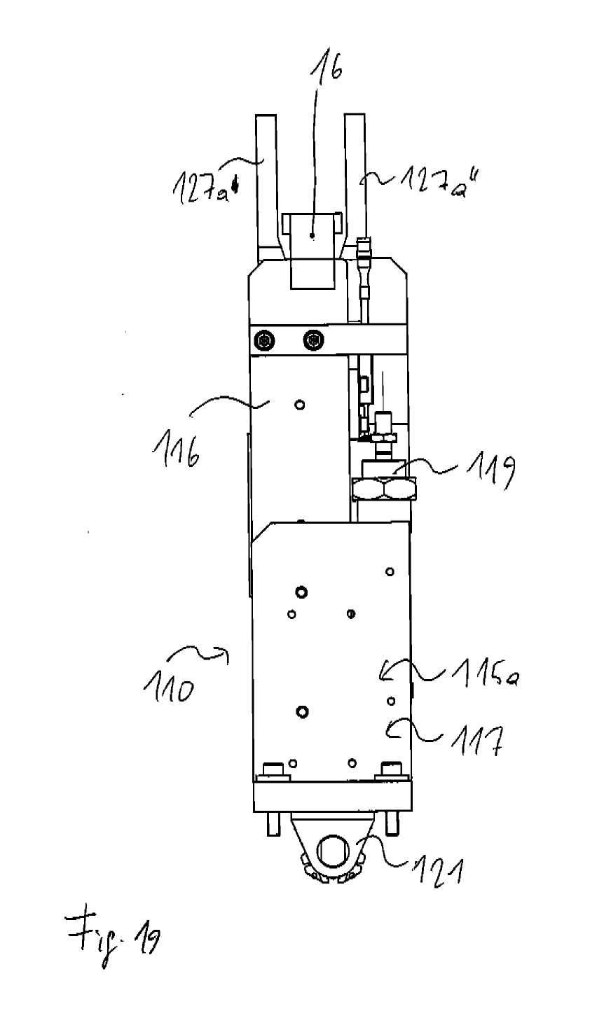

FIG. 19: a side view of the second embodiment of the working tool; and

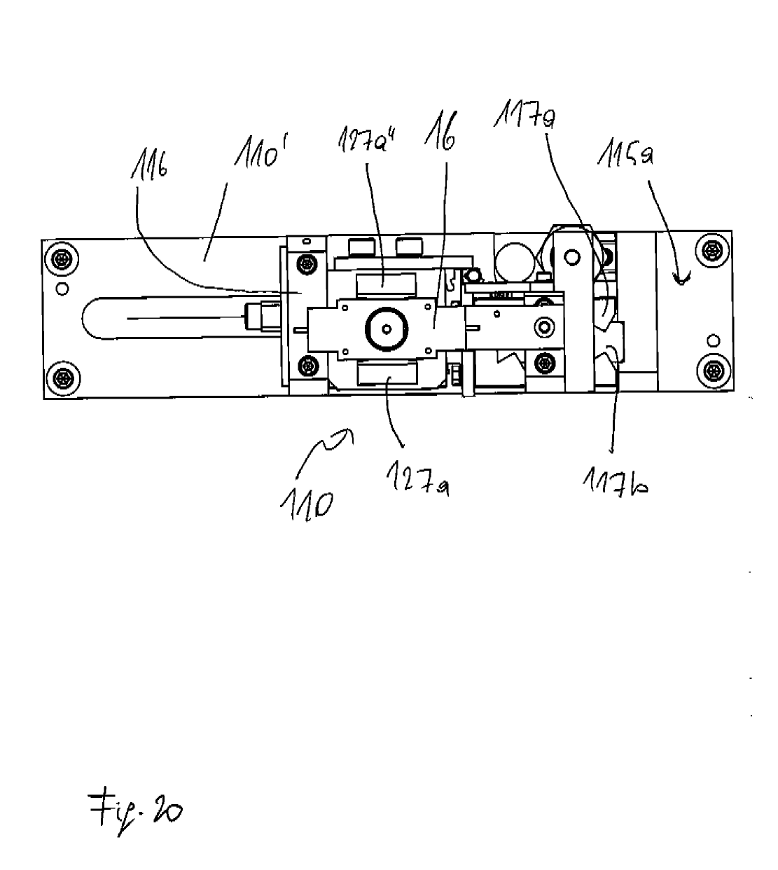

FIG. 20: a top view of the second embodiment of the working tool.

In FIGS. 1 to 6 there is now shown a first embodiment of an apparatus, designated with 1, for a punching and a connecting of a work piece W, only schematically shown in the figures, which comprises a frame 2, in which—in the here shown embodiment—four working tools 10a-10d are arranged. Each working tool 10a-10d is formed two-parted and each has an upper tool 10a′-10d′ and a lower tool 10a″-10d″. The design of the working tools 10a-10d will be explained below by FIGS. 7 and 8.

The apparatus 1 has a turntable 20 having an under table 21 stationary mounted on the frame 2 of the apparatus 1. An upper table 22 of the turntable 20 is hinged at the under table 21 by a hinge joint 23, not shown in detail, so that the upper table 22 is pivotable relatively to the under table 21 around a hinge axis. Two receptables 23a, 23b carrying the work piece W are arranged at the upper table 22. In the shown case the work piece W is a fender of a vehicle, into which four punching holes are to be provided and a connection of the fender with an insert is to be performed, as described below. It is apparent for the skilled person, that apparatus 1 is not only usable for a fender. It is possible, in particular, to work on components for siding of a car body, particularly bumpers, front and rear panels or the kind. Also, the apparatus 1 is not restricted for use in automotive applications, but is also usable for a plurality of other areas of technology.

The lower tools 10a″-10d″ of the working tools 10a-10d are arranged on the upper table 22 of the turntable 20, so that by a pivoting movement of the upper table 22 the lower tools 10a″-10d″ of the working tools 10a-10d fixed thereon are simultaneously pivoted too.

At the frame 2 of apparatus 1—as shown best in FIGS. 1 and 3—two carrier plates 4a, 4b are fixed, on which the upper tools 10a′-10d′ of the working tools 10a-10d are arranged. Naturally, herein the upper tool 10a′-10d′ of each working tool 10a-10d is aligned in such a manner to its associated lower tool 10a″-10d″, that during a working process the upper tools 10a′-10d′ co-operate with the lower tools 10a″-10d″.

For better understanding of the operation of apparatus 1 and before an explanation thereof is given, a description of the working tools 10a-10d is given first: The FIGS. 7 and 8 now show a first embodiment of the working tool 10a, the further working tools 10b-10d of the apparatus are preferably similarly designed. In FIGS. 7 and 8 one can see again the upper tool 10a′ and the lower tool 10a″. The upper tool 10a′ is designed as punching tool and comprises a punching head 11, which impinges a punching die 12, so that the latter is movable relatively to the lower tool 10a″. The punching die 12 is surrounded by a wiper or a blank holder 13, so that the work piece W is sufficiently held in postion during a punching process. Such a punching head 11 is known in principle and thus it is not be described in more detail.

Substantial is now the design of the lower tool 10a″. This comprises two working units 14a and 14b, which are movable relatively to the upper tool 10a′, so that optionally the first working unit 14a or the second working unit 14b is positionable under the upper tool 10a′ to co-operate with this upper tool 10a′. In the shown embodiment this is achieved in that the two working units 14a, 14b are movable by means of a moving device 15′, here a carriage 15, in a shift motion running substantially orthogonal to direction Z, thus the direction of the feed movement of the lower tool 10a″ to its associated upper tool 10a′, therefore in direction X of FIG. 7: the working units 14a, 14b are arranged on a carriage table 15a of the carriage 15, which is movably mounted on a carriage guide 15b. By a shift of the carriage table 15a along the carriage guide 15b thus—as shown in FIG. 7—the first working unit 14a can be positioned under the upper tool 10a′. By a respective shift motion of the carriage table 15a in FIG. 7 to the left, then the second working unit 14b is positioned under the upper tool 10a′ of the working tool 10a. It is apparent for the skilled person, that the construction described above—both working units 14a and 14b are positioned on a common carriage 15—although advantageous is not mandatory. It is also possible, that the two working units 14a, 14b—for example by providing a carriage for each of them—are movable separately from each other. Also is it not mandatory, that—as in the described embodiment—only two working units 14a, 14b are provided. It is also possible, that the lower tool 10a″ comprise three or more working units 14a, 14b movable relatively to the upper tool 10a′.

In the case described herein the first working unit 14a of the lower tool 10a″ serves for punching of an opening in the work piece W. Thus, the first working unit 14a comprises a die 16, which co-operates with the punching die 12 of the upper tool 10a′. The die 16 is movable by a lifting unit 16a in direction of the upper tool 10a′ and thus movable to and away from the punching die 12.

The second working unit 14b serves for connecting of an insert E (shown in FIG. 7) with the work piece W. In the case described herein this is performed by ultrasonic welding. Therefore, the second working unit 14b comprises an ultrasonic unit 17 with a sonotrode 17a and a vibration generator 17b. A lifting apparatus 17c (see FIG. 8) serves for moving the sonotrode 17a to the upper tool 10a′, as shown in FIG. 8. Naturally, it is also possible to glue, join or connect the insert E by another kind instead of ultrasonic welding for connecting. For the skilled person the modifications which are then needed are apparent, so that they are not described in further detail.

The functioning of apparatus 1 according to the first embodiment is as follows: As best shown in FIG. 3, the upper table 22 of the turntable 20 is moved in front for insertion of the work piece W in the apparatus 1. Before the work piece is applied on the receptables 23a, 23b of the turntable 20, however—as shown in FIG. 8—the inserts E, which are to be connected with the work piece W, here to be welded, are applied on the second working units 14b of the lower tools 10a″-10d″. In the case described herein, the inserts E are thus applied on the sonotrodes 17, which function as joining head.

Thereafter, the work piece W is pivoted under the upper tools 10a′-10d′ of the working tools 10a-10d pivoting movement of the turntable 20, which can be performed in a simple manner. Usually the positioning of the work piece W under the upper tools 10a′-10d′ is performed by this pivoting movement. However, it can not be excluded, that by this purpose the turntable is moved a short distance into the direction of the upper tools 10a′-10d′.

The construction described above has the advantage, that by using the turntable 20 for positioning of the work piece W under the upper tools 10a′-10d′ and the arrangement of the lower tools 10a″-10d″ on the turntable 20, the described apparatus 1 builds less deep and thus more compact and thus needs little space in the assembly hall. Moreover, a short pivoting movement can be realized considerably easier as a long shifting movement, as used in the known apparatuses, where a shift table shuttles between the welding station and the connecting station.

After performing of the positioning movement of the work piece W by the turntable 20, the turntable 20 and thus the work piece W is under the upper tools 10a′-10d′ in the position shown in FIGS. 4 to 6.

For punching of the to be inserted holes into the work piece W—as shown in FIG. 7—the first working units 14a of the lower tools 10a″-10d″ of the working tools 10a-10d are positioned, wherein the working tools 10a-10d are formed herein as combined punching and connecting tools, so that the dies 15 of the first working units 14a are arranged under the punching dies 12 of the upper tools 10a′-10d′. By a lifting motion of the lifting units 16a the dies 16 are then brought in contact with the inner side of the work piece W and thus function as counterholder for the punching dies 12. By the punching movements of the punching dies 12, which are known in principle and thus not described in detail, the punching holes are formed in the work piece W.

After production of these holes the punching dies 12 are slightly moved away from the work piece W. The same way the dies 16 which are in contact with the work piece W are moved away from the work piece W by a backward movement of the lifting units 16a.

Then, by a movement of the carriage 15 the two working units 14b are positioned under the upper tools 10a′-10d′, as shown in FIG. 8. By a feed movement of the lifting devices 17c, the sonotrodes 17a together with the inserts E mounted thereon are moved to the work piece W, pressed against it and the inserts E are connected with the work piece W by an ultrasonic impingement of the latter. The working process is thus completed.

Then, for handling of the work piece W, the turntable 20 is pivoted back again together with the work piece W from its working position shown in FIG. 6 to its loading position shown in FIG. 3 and the work piece W can be easily removed from the apparatus 1.

A second embodiment of the apparatus is shown in FIGS. 9 to 14, wherein corresponding components are provided with the same reference sign and are not described any more. The substantial difference between the first and second embodiment is not, that the apparatus 1 of the second embodiment comprises six working tools 10a-10f having upper tools 10a′-10f′ and lower tools 10a′-10f′, but that it comprises a handling device 30 by which the work piece W mounted on the turntable 20 can be removed from the apparatus in the working position of the apparatus 1.

The use of the handling device 30 for the work piece W has as a consequence, that the upper tools 10a′-10f′ of the working tools 10a-10f are now not any more—at in the first embodiment of the apparatus 1—mounted on carrier plates 4a, 4b arranged substantially stationary in the apparatus 1, but that it is provided, that—as best seen in FIGS. 9 and 10—a carrier plate 34 can be moved by a lifting unit 31 of the handling device 30. The latter comprises carrier guides 32a, 32b on which the carrier plate 34 can be moved slidewise.

FIG. 9 now shows the apparatus 1 together with the work piece W after the completion of the working process, thus after holes are inserted in the work piece W by a punching process and the inserts E have been welded with the work piece W. In order to easily remove the work piece from the apparatus 1, grippers 35 (see FIG. 10) of the handling device 30 are extended and embrace the work piece W. By means of the lifting unit 31 of the handling device 30—as shown in FIGS. 12 and 13—the carrier plate 34 together with the upper tools 10a′-10f′ arranged thereon and the work piece W are moved in an upward direction, thus away from the lower tools 10a″-10f″. The work piece W can then be removed from the handling device 30 by a not shown operation device.

Simultaneously or thereafter—as shown in FIG. 14—the turntable 20 is moved forwardly into its loading position and the next work piece W can be inserted in the apparatus 1.

In the description above it is assumed, that the upper tools 10a′-10d′ or 10a′-10f′, respectively, serve for punching and the lower tools 10a″-10d″ or 10a″-10f″, respectively, serve for connecting. Naturally, this can also be vice versa, i.e. the lower tools 10a″-10f″ or 10a″-10f″, respectively, serve for punching and the upper tools 10a′-10d′ or 10a′-10f′, respectively, serve for connecting.

In FIG. 15 is now shown an enlarged view of the turntable 20 of the first embodiment. Again, one can see the four lower tools 10a″-10d″. To easily work on closely adjacent parts of the work piece W, it is provided, that the lower tools 10a″-10f″ are arranged on a carrier plate 25, which is guided in guides 26a, 26b and is thus movably arranged in turntable 20, so that the lower tools 10a″-10f″ are relatively movable to the associated upper tools 10a′-10f′ by means of the movable carrier plate 25.

A second embodiment of a lower tool 110 of the apparatus 1 is shown in FIGS. 16 to 20, which in its function corresponds to the lower tool 10a shown in FIGS. 7 and 8. Thus, one or a plurality of the lower tools 10a-10d or 10a-10f, respectively, of the apparatus 1 can be replaced by the lower tool 110 according to the second embodiment. The substantial difference between the two embodiments of the lower tools is, that the working units 114a and 114b of the lower tool 100, corresponding to the working units 14a and 14b, are not optionally moved any more by a feed motion along a substantially orthogonal to the direction Z of the shifting movement running to the associated upper tool—as for the lower tool 10a—but that the two working units 114a and positioned are moved in the feed direction Z of the lower tool 110 relatively to the upper tool 10a′, without that there is basically a shift of the working elements 114a, 114b in the orthogonal direction X hereto: It is provided, that the first working unit 114a is movable to and away from each of the upper tool 10a′ by means of a first moving unit 115a and that the second working unit 114b is movable to and away from each of the upper tool 10a′ by means of a second moving unit 115b. In the here shown second embodiment of the working tool 110, this is accomplished in an advantageous manner as described as follows:

According to the working unit 14a of the first embodiment, the first working unit 114a of the second embodiment also serves for punching a hole in work piece W and thus comprises a die 16, which co-operates with the punching die 12 of the upper tool 10a′. The die 16 is carried by a U-shaped frame 116, which is movable by the first moving unit 115a in direction of the arrow Z. For that—as can be best seen in FIGS. 16 to 18—it is provided, that the working unit 114a is arranged on a carriage table 117a of a carriage 117 of the moving unit 115a. The carriage 117 is arranged substantially orthogonal to a basic element 110′, so that by a shift motion of the carriage table 117a along a carriage guide 117b a movement of the first working unit 114a in Z-direction can be performed. It is provided, that the moving unit 115a has a hydraulic or pneumatic piston 119, its piston rod 119a engages on a cantilever 116a of the U-shaped frame 116 of the first working unit 114a. By extending the piston rod 119a of the piston 119 the feed movement of the working unit 114a and hence of die 16 is then performed in the direction to the punching head 12 of the upper tool 10a (see FIGS. 17 and 18).

Now, to not or not exclusively compensate the load arising during the punching process of the first working unit 114a by the moving unit 115a, a supporting element 120 is provided in the described embodiment, that is movable under the first working unit 114a by a driving device 121—as shown in FIGS. 17 and 18. In the position of the first working unit 114a shown in FIG. 17, a lower beam 116b of the frame 116 rests on the ground plate 110′ and the supporting element 120 is in its starting position, in which it is outside of the frame 116 of the first working unit 114a. If the first working unit 114a—as described above—is now lifted by the first moving unit 115a, the supporting element 120 can—as shown in FIG. 18—be moved under the first working unit 114a. The lower beam 116b of the U-shaped frame 116 then touches the upper side of the supporting element 120 and the piston 119a can then be moved back.

The second working unit 114b is arranged in the U-shaped frame 116 of the first working unit 114a, so that it is taken along by its movement. Again, it also comprises an ultrasonic unit 127 with a sonotrode 127a and a ultrasonic generator 127b, wherein in the here shown case (see FIGS. 16 and 19) the sonotrode 127a is formed fork-like and has two sonotrode elements 127a′ and 127a″. As it can be seen best from these figures, the two sonotrode elements 127a′ and 127a″ are arranged on both sides of the die 16 and extend above these.

The here described working tool 114b serves particularly for welding together tubular work pieces as for example a sensor holder of a vehicle, which is to be welded onto a fender.

But it is also possible, that instead of tubular work pieces also rod-shaped work pieces are welded together. At the here described embodiment of the second working unit 114b with sonotrode elements 127a′ and 127a″ extending above the die 16, it is necessary, that the upper end of the insert E lies above the upper end of the sonotrode elements 127a′ and 127a″, so that the insert E received between the two sonotrodes 127a′ and 127a″ extends above these and can be pressed against the work piece W by the die 16, wherein the above-mentioned tubular or rod-shaped insert E is to be welded together with the work piece W. For the skilled person the modifications, which have to be performed, are easily seen, so that they must not be described in detail.

The second working unit 114b is moved by the second working unit 115b. The latter comprises a carriage 125, its carriage table 125a being arranged on a carriage guide 125b carries the ultrasonic unit 127, so that by a movement of the carriage 125 the latter is movable in direction of the upper tool 10a. A hydraulic or pneumatic piston 129 serves again for operation of the carriage 125 of the second moving unit 115b, its piston rod 129′ impinging the carriage 125. Instead of the pneumatic piston 129 as used herein—as for all other described pistons too—an electric drive can be provided.

The functioning of one or a plurality of lower tools 110 according to the second embodiment providing apparatus 1 is now as follows: Firstly again—as seen from FIG. 3—the upper table 22 of the turntable 20 is moved in front for insertion of work piece W in the apparatus 1. Before putting the work piece W on the receptable 23a, 23b of the turntable 23, the insert which should be welded together with the work piece W is laid on the die 16 of the first working unit 114. As described above, its upper end extends above the upper ends of the sonotrode elements 127a′ and 127a″. Then the work piece W is applied on the receptable 23a, 23b of the turntable 20 and the latter is pivoted under the upper tools 10a′-10d′ or 10a′-10f′, respectively, of the working tools 10a-10d or 10a-10f, respectively, by a simple pivoting movement. It is also here the advantage, that by using the turntable 20 for positioning of the work piece W under the upper tools 10a′-10d′ or 10a′-10f′, respectively, by the turntable, the described apparatus 1 builds less deep and hence more compact and thus occupies a smaller space in the assembly hall.

After performing this positioning movement of the work piece W by the turntable 20, the latter and thus the work piece W is again in the position shown in FIGS. 4 to 6 under the upper tools 10a′-10d′. To now insert the punching holes in the work piece W, the first working unit 114a together with the inserts E applied on its dies 16 is then lifted by the first moving units 115a and the inserts E are pressed against the work piece W and thus form—in the same way as described before—counter holder for the punching dies 12 of the upper tools 10a′-10d′. By the punching movement of the punching die 12, which is known in principle and thus not described in detail, the punching holes are then formed in the work piece W. To now weld the inserts E to the work piece W, the second working units 114b are moved forward by their associated second moving units 115b in direction of the work piece W and therefore of the associated upper tool 10a′-10d′. The sonotrode elements 127a′ and 127a″ are pressed against the work piece W and the inserts E are connected with these via an ultrasonic impingement. The working process is thus completed.

For handling of the work piece W, the turn table 20 is pivoted back again together with the work piece W from its working position shown in FIG. 6 to the working position shown in FIG. 3 and the work piece W can be easily removed from apparatus 1.

1. Apparatus for working, particularly for punching and connecting of a work piece, particularly of plastic parts of a vehicle, wherein the apparatus (1) comprises at least one working tool (10a10d; 10a-10f) comprising an upper tool (10a′-10d′; 10a′-10f′) and a lower tool co-operating with the upper tool, wherein the upper tool or a plurality of upper tools (10a′-10d′; 10a′-10f′) are arranged in the apparatus (1) wherein
the lower tool or a plurality of lower tools (10a″-10d″; 10a″-10″f) are arranged on a turntable (20) of the apparatus (1), which is pivotable from a loading position, in which the turntable (20) is remote from the upper tool or plurality of upper tools (10a′-10d′; 10a′-10f′), to a working position, in which the lower tool or the plurality of lower tools (10a′-10d′; 10a′-10f′) are aligned with the co-operating upper tool or plurality of upper tools, so that by a pivoting movement of the turntable (20) the work piece (W), inserted into the apparatus (1) during the loading position of the turntable (20), as well as the lower tool or the plurality of lower tools (10a″-10d″; 10a″-10f″) can be brought under the upper tool or the plurality of upper tools (10a′-10d′; 10a′-10f′).

2. Apparatus according to claim 1, wherein
the upper tool or the plurality of upper tools (10a′-10d′) is arranged on at least one stationary arranged carrier plate (4a, 4b) in the apparatus (1).

3. Apparatus according to claim 1, wherein
the upper tool or the plurality of upper tools (10a′-10f′) of the working tools (10a-10f) of the apparatus (1) is arranged so that it can be moved away from the lower tool or the plurality of lower tools (10a″-10f″).

4. Apparatus according to claim 3, wherein
the upper tool or the plurality of upper tools (10a′-10f′) is arranged on a carrier plate (34) which is movable by a lifting device (31).

5. Apparatus according to claim 1, wherein
the apparatus (1) comprises a handling device (30) by which the work piece (W) arranged on the turning table (20) can be engaged in the working position of the apparatus (1) and can be moved away from the lower tool or the plurality of lower tools (10a″-10f″).

6. Apparatus according to claim 1, wherein
the lower tools (10a′-10d′; 10a″-10f″) are shiftably arranged in at least one direction.

7. Apparatus according to claim 1, wherein
at least one upper tool (10a′-10d′; 10a′-10f′) comprises a punching tool.

8. Apparatus according to claim 1, wherein
at least one lower tool (10a″-10d″; 10a″-10f″) comprises a connection tool.

9. Working tool for an apparatus for working, particularly for an apparatus for punching and connecting of a work piece, hereby particularly for an apparatus according to one of the previous claims, wherein the apparatus (1) comprises an upper tool (10a′) and the working tool (10a) comprises a lower tool (10a″; 110 resp.) with at least two working units (14a, 14b; 114a, 114b resp.) movable to and away from the upper tool (10a′), wherein the lower tool (10a″, 110) comprises at least one moving device (15′; 115a, 115b) by which at least the first working unit (14a) and the second working unit (14b) are optionally movable relatively to the upper tool (10a′) of the working tool (10a), wherein at least one moving device (15′, 115a; 115b) comprises a carriage (15; 117; 124) comprising a carriage table (15a; 117a; 124a) upon which at least one working unit (14a, 14b; 114a; 114b) is arranged and wherein the carriage table (15a; 117a; 124a) of the carriage (15; 117, 124) is shiftably arranged on a carriage guide (15b; 117b, 124b) wherein the shift motion of the carriage (15; 117; 124) is essentially in the direction (Z) of the feed motion of the lower tool (10a″) to its associated upper tool (10a′) or orthogonal to this direction (Z).

10. Working tool according to claim 9, wherein
the upper tool (10a′) of the apparatus (1) comprises a punching head (11) and a punching die (12) and wherein at least one of the working units (14a; 114a) comprises a die (16), which co-operates with the punching die (12) of the upper tool (10a), and at least one working unit (14b; 114b) of the lower tool (10a″) is formed as a connecting unit.

11. Working tool according to claim 9, wherein
the first as well as the second working tool (14a; 14b) is optionally positionable under the associated upper tool (10a′-10d′; 10a′-10f′) by the moving device (15′).

12. Working tool according to claim 9, wherein
each working unit (114a; 114b) is associated to a moving device (115a; 115b) and the corresponding working unit (114a; 114b) can be fed to the upper tool (10a′-10d′; 10a′-10f′) by a feed movement of its associated moving device (115a; 115b).

13. Working tool according to claim 12, wherein at least two working units (14a, 14b) are arranged on the carrier (15) of the moving device (15′).

14. Working tool according to claim 9, wherein each carriage (117, 124) carries a working unit (114a, 114b).

15. Working tool according to claim 9, wherein the working tool (110) comprises a frame (116), which is shiftable in direction (Z) to the upper tool (10a) by the first moving device (115a).

16. Working tool according to claim 15, wherein the frame (116) is arranged on the carrier table (117a) of the carrier (117).

17. Working tool according to claim 15, wherein the working tool (110) comprises a supporting element (120) which is movable under the frame (116) by a drive unit (121).

18. Working tool according to claim 15, wherein the second working unit (14b) is arranged in the frame (116).

19. Working tool according to claim 9, wherein at least one working unit (14b, 114b) comprises a sonotrode (17, 117).
